(19) United States
(12) Patent Application Publication
(10) Pub. No.: US 2023/0003531 A1
(43) Pub. Date: Jan. 5, 2023

(54) MATCHING COORDINATE SYSTEMS OF MULTIPLE MAPS, BASED ON TRAJECTORIES

(71) Applicant: Robert Bosch GmbH, Stuttgart (DE)

(72) Inventors: Tobias Strauss, Obersulm (DE); Carsten Hasberg, Ilsfeld-Auenstein (DE)

(21) Appl. No.: 17/620,844

(22) PCT Filed: Jun. 8, 2020
(86) PCT No.: PCT/EP2020/065792

§ 371 Date: Feb. 7, 2022

(30) Foreign Application Priority Data
Jun. 27, 2019 (DE) 10 2019 209 398.1

(51) Int. Cl. G01C 21/32; G01C 21/00

(52) U.S. Cl. CPC G01C 21/32; G01C 21/3819

(57) ABSTRACT

A method for aligning digital maps, in particular by a control unit. Data of a first map present in a first coordinate system and data of a second map present in a second coordinate system are received. At least one trajectory within the first map and at least one trajectory within the second map are ascertained based on the received data. The data of the first coordinate system and the data of the second coordinate system are aligned with one another based on the respective trajectories. A transfer system, a control device, a computer program, and a machine-readable memory medium are also described.

### FIELD

The present invention relates to a method for aligning digital maps, a control unit, a computer program, and a machine-readable memory medium.

### BACKGROUND INFORMATION

For the automated operation of vehicles, for example in a fully automated operating mode, highly accurate planning maps are used. Such planning maps may include, for example, geometries of lanes of the drivable roadways and may simplify the vehicle-side perception of the lanes. In particular, an anticipatory driving mode may be implemented by the use of planning maps.

In order to utilize the existing map information during automated operation of the vehicle, it is necessary to locate the vehicle within the planning map. In addition, to increase the accuracy and availability of a GPS-based localization, localization maps are used which contain features that are detectable using a vehicle sensor system, and which thus make it possible to locate the vehicle with the aid of the vehicle sensor system.

The map-based localization may be effectively used when the coordinate systems of all maps or map layers are correctly coordinated with one another. However, the creation of planning maps, often independently of the localization map, is problematic, as the result of which discrepancies in the coordinate systems of the maps may be present.

### SUMMARY

An object underlying the present invention is to provide a method for aligning maps with coordinate systems that differ from one another.

This object may be achieved via the present invention. Advantageous embodiments of the present invention are disclosed herein.

According to one aspect of the present invention, a method for aligning digital maps is provided. The method may preferably be carried out by a control unit.

In accordance with an example embodiment of the present invention, in one step, data of the first map present in a first coordinate system and data of the second map present in a second coordinate system are received.

At least one trajectory within the first map and at least one trajectory within the second map are ascertained based on the received data.

The data of the first coordinate system and the data of the second coordinate system are subsequently aligned with one another based on the respective trajectories.

By use of the method, already traveled and/or possible trajectories along the maps may be used as criteria for matching the coordinate systems of the particular maps. The matched maps may subsequently be used by a vehicle or provided for use in vehicles. The provision of the matched maps may take place via a vehicle-external server unit, for example.

The vehicle may be operable with assistance, semi-automatedly, highly automatedly, and/or fully automatedly, i.e., without a driver, according to the BASt (German Federal Highway Research Institute) standard.

According to a further aspect of the present invention, a control unit is provided, the control unit being configured to carry out the method. The control unit may be, for example, a vehicle-external control unit or a vehicle-external server unit such as a cloud system. The control unit may preferably receive measured data from vehicle sensors, or data from databases.

Furthermore, according to one aspect of the present invention a computer program is provided that includes commands which, when the computer program is executed by a computer or a control unit, prompt the computer or control unit to carry out the method according to the present invention. According to a further aspect of the present invention, a machine-readable memory medium is provided on which the computer program according to the present invention is stored.

The method according to the present invention may be used, for example, when planning maps are present but no direct sensor measurements for elements contained in the planning map are present. In addition, the method may be used to match at least two maps with regard to their coordinate systems when the maps have been generated by different measuring runs, for example by different manufacturers.

In accordance with an example embodiment of the present invention, the accuracy of the matching of the maps may preferably be increased with an increasing number of ascertained or provided trajectories. For this purpose, the ascertained trajectories may be possible trajectories along the maps or may be designed as trips that are already carried out.

The orientation of the first map and of the second map preferably takes place based on the trajectories in the first map and the second map. The maps are rotated and shifted in such a way that the trajectories are approximately congruent and thus essentially overlap. For a plurality of trajectories, distributions of the trajectories as well as average values may be used for matching the maps.

By using the trajectories as criteria for the orientation of the maps, maps having no shared features may also be aligned with one another. For example, a map fusion may take place even if the features stored in the maps allow no direct orientation. Since only an indirect orientation of the maps or of their coordinate systems takes place via the trajectories via the statistics of the traveled trajectories, for the accuracy it is advantageous to use a sufficiently large number of trajectories.

According to one specific embodiment of the present invention, for a translatory and/or rotatory orientation of the maps, the ascertained trajectories in the particular maps are brought into an at least approximate overlap. In this way, the data of the maps may be shifted and rotated relative to one another to achieve an optimal overlap of the ascertained trajectories in the maps. Particularly precise matching of the coordinate systems of the maps may thus be achieved.

According to a further exemplary embodiment of the present invention, the orientation of the maps is carried out along the at least one ascertained trajectory and/or along a map grid, as a function of location. The shift or the relative deviation of the two maps from one another is generally not identical for all areas of the particular map. In particular, the deviation between the maps may be locally variable. As a result, a transformation field in which the shift and/or the rotation of the maps are/is a function of a location, not an individual estimation of a shift and/or a rotation, is necessary. Such a location-dependent matching of the maps may be implemented, for example, via a suitable compensation computation and/or an optimization problem that aims to optimally align the existing measurements with a statistical model trajectory or some other set of measured trajectories.

According to a further exemplary embodiment of the present invention, the at least one trajectory of the first map and/or the at least one trajectory of the second map are/is measured, simulated, or computed. In addition to a recording of trajectories along the maps, at least one possible trajectory may also be computed or simulated. Such a statistical model trajectory may now be used for carrying out transformation between the maps. In particular, such trajectories may be used for which the probability of the measured trajectories is maximized for the given lanes. The accuracy of the estimation of the transformation is a function of the accuracy of the statistical model or of the computation of the model trajectory, and of the number of available measured trajectories.

According to a further specific embodiment of the present invention, the at least one trajectory is ascertained by machine learning in the first and/or the second map. As a result, a neural network may be used to generate one or multiple possible trajectories within the at least one map. The generated trajectories are subsequently used as indicators or criteria for matching of the coordinate systems of the maps.

Such model trajectories may be ascertained from measurement series of trajectories with a known position within the lane, with the aid of machine learning methods. For this purpose, a driver, a vehicle size, a vehicle with left-hand or right-hand drive, left-hand or right-hand traffic, neighboring lanes, two-way traffic, curve shape, present vehicle speed, and the like may be taken into account as influencing factors.

According to a further specific embodiment of the present invention, the data of the first coordinate system are aligned with the data of the second coordinate system, or the data of the second coordinate system are aligned with the data of the first coordinate system. The computation effort may be reduced in this way, since only one map is transformed or adapted to another map. Adapting both maps may thus be dispensed with.

According to a further exemplary embodiment of the present invention, for aligning the maps, curves and changes in direction of the at least one trajectory of the first map and of the at least one trajectory of the second map are ascertained, compared to one another, and matched to one another. Often, only the orientation transverse to the travel direction is possible, since a shift in the travel direction generally has little or no influence on the probability of the measured trajectories. By use of the various observable directions, the ability to completely determine the shift may be ascertained only at intersections or in areas with winding roadways.

Thus, by assuming smoothness of the transformation between the two map coordinate systems, the lateral orientation which is determinable in various global directions, and the orientation which is completely determinable at intersections, may be used to estimate the transformation of the at least one map.

According to a further exemplary embodiment of the present invention, the first map is designed as a localization map, the at least one trajectory of the first map being ascertained by measurements. In particular, the at least one trajectory, as a trip that is already carried out by a vehicle, may be stored in a memory or be receivable by the control unit. In addition, measuring runs for creating the localization map may likewise be taken into account as trajectories. Furthermore, the localization map may contain landmarks that are ascertainable by a vehicle sensor system to enable a localization process of the vehicle.

According to a further specific embodiment of the present invention, the second map is designed as a planning map, the at least one trajectory of the second map being computed or simulated within the planning map. The planning map may include, for example, geometries and profiles of lanes as localization elements. Furthermore, the localization elements may be designed as roadway intersections, distinctive landscape features, and the like. The localization map may be designed, for example, as a radar map and/or as a so-called video road signature.

According to a further exemplary embodiment of the present invention, the at least one ascertained trajectory is detected based on an already traveled route of a vehicle and/or a plurality of vehicles. The ascertained trajectories may thus be obtained from different sources, such as neighboring vehicles, external server units, and the like, and used for matching the coordinate systems of the maps. With an increasing number of trajectories used, matching of the coordinate systems of the maps may be carried out with greater accuracy.

Preferred exemplary embodiments of the present invention are explained in greater detail below with reference to greatly simplified schematic illustrations.

### BRIEF DESCRIPTION OF THE DRAWINGS

FIG. 1 shows a top view onto a vehicle including a control unit according to the present invention according to one specific embodiment of the present invention.

FIG. 2 shows a schematic top view onto a roadway section for explaining a method according to one specific embodiment of the present invention.

FIG. 3 shows a schematic illustration of trajectories for explaining the method according to one specific embodiment of the present invention.

### DETAILED DESCRIPTION OF EXAMPLE EMBODIMENTS

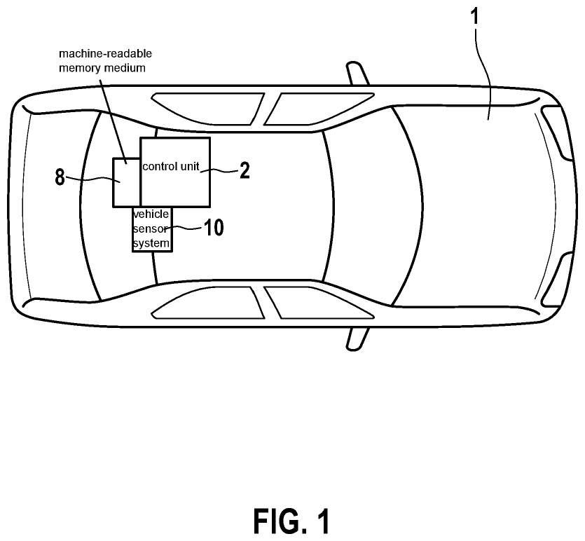

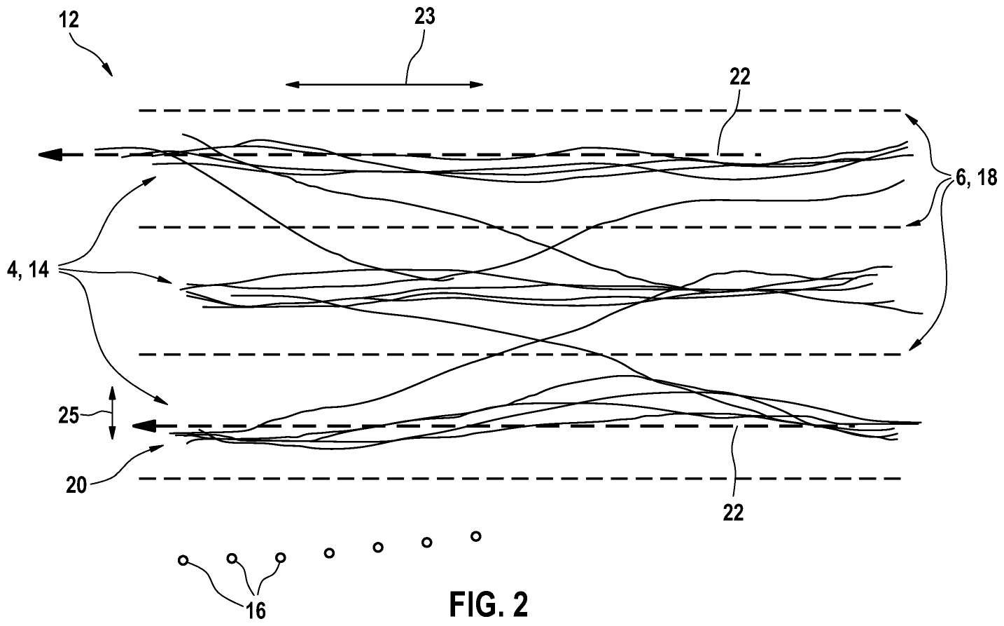

FIG. 1 shows a top view onto a vehicle 1 that includes a control unit 2 according to one specific embodiment of the present invention. Control unit 2 is configured to carry out a method for aligning digital maps 4, 6, illustrated by way of example in FIG. 2. For this purpose, control unit 2 is connected to a machine-readable memory medium 8 on which a computer program is stored.

Control unit 2 may access data and the computer program of machine-readable memory medium 8, and execute or utilize same.

Furthermore, control unit 2 is connected to a vehicle sensor system 10 in a data-conveying manner. According to the illustrated exemplary embodiment, vehicle sensor system 10 is made up of a radar sensor.

Alternatively or additionally, vehicle sensor system 10 may include camera sensors, GNSS sensors, LIDAR sensors, ultrasonic sensors, and the like.

By evaluating measured data of vehicle sensor system 10, control unit 2 may for example ascertain trajectories of vehicle 1 and store them in machine-readable memory medium 8. Control unit 2 may thus create a first map 4 which contains the measured data of vehicle sensor system 10.

FIG. 2 illustrates a schematic top view onto a roadway section 12 for explaining the method. Two maps 4, 6, superimposed on one another, are shown.

First map 4 is designed as a localization map, and includes a plurality of trajectories 14 that have been recorded by control unit 2 during trips of vehicle 1.

In addition, localization elements 16 at the roadside have been ascertained. Localization elements 16 are, for example, guide posts that are detected by vehicle sensor system 10.

Second map 6 is a planning map, and includes lane markings 18 and the profile of particular lanes 20.

Superimposed maps 4, 6 are slightly mismatched, so that the coordinate systems of maps 4, 6 must first be adapted to one another before, for example, second map 6 is usable by control unit 2 for localization of vehicle 1.

For this purpose, in one step one or multiple model trajectories 22 are computed by control unit 2, for example. The computation of model trajectories 22 may take place, for example, based on the dimensions of vehicle 1 and the dimensions and a profile of lanes 20. A theoretical trip of vehicle 1 may be simulated by second map 6.

Measured trajectories 14 and computed trajectories 22 are subsequently used as criteria for matching the coordinate systems of the two maps 4, 6. Maps 4, 6 may, for example, be shifted or rotated relative to one another until trajectories 14, 22 are optimally situated one on top of the other.

For this purpose, an average deviation of trajectories 14, 22 from one another may be minimized as a function of the profile of trajectories 14, 22. Arrows 23, 25, 27 illustrate possible transformation directions of maps 4, 6.

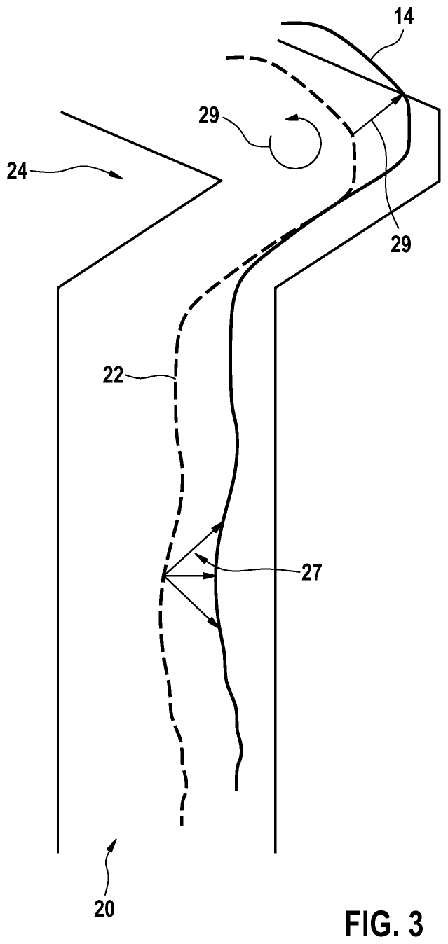

FIG. 3 shows a schematic illustration of further trajectories 14, 22 for explaining the method. The two trajectories 14, 22 illustrate the differences of the coordinate systems between first map 4 and second map 6 at a curve 24.

In particular, ambiguities in the matching of trajectories 14, 22 along the straight route sections are illustrated. Arrows 27 illustrate the transformation directions that are not unambiguously determinable. These ambiguities may be unambiguously resolved in the curved area. The corresponding transformation directions for matching trajectories 14, 22 are illustrated by arrows 29. So-called aperture problems in the area of straight route sections may thus be resolved by matchings in curved areas.

1-13. (canceled)

14. A method for aligning digital maps by a control unit, the method comprising the following steps:
receiving data of a first map present in a first coordinate system and data of a second map present in a second coordinate system;
ascertaining, based on the received data, at least one trajectory within the first map and at least one trajectory within the second map; and
aligning the data of the first map in the first coordinate system and the data of the second map in the second coordinate system with one another based on the ascertained at least one trajectory within the first map and the ascertained at least one trajectory within the second map.

15. The method as recited in claim 14, wherein for a translatory and/or rotatory orientation of the first and the second maps, the ascertained at least one trajectory within the first map and the ascertained at least one trajectory are brought into an at least approximate overlap.

16. The method as recited in claim 15, wherein the orientation of the first and second maps is carried out along the ascertained at least one trajectory within the first map and the ascertained at least one trajectory and/or along a map grid, as a function of location.

17. The method as recited in claim 14, wherein the at least one trajectory of the first map and/or the at least one trajectory of the second map is measured, or simulated, or computed.

18. The method as recited in claim 17, wherein the at least one trajectory of the first map and/or the at least one trajectory of the second map is computed by machine learning.

19. The method as recited in claim 14, wherein the data of the first map in the first coordinate system are aligned with the data of the second map in the second coordinate system, or the data of the second map in the second coordinate system are aligned with the data of the first map in the first coordinate system.

20. The method as recited in claim 14, wherein for aligning the first and second maps, curves and changes in direction of the at least one trajectory of the first map and of the at least one trajectory of the second map are ascertained, compared to one another, and matched to one another.

21. The method as recited in claim 14, wherein the first map is a localization map, the at least one trajectory of the first map being ascertained by measurements.

22. The method as recited in claim 14, wherein the second map is a planning map, the at least one trajectory of the second map being computed or simulated within the planning map.

23. The method as recited in claim 14, wherein the at least one trajectory within the first map and the at least one trajectory within the second map are detected based on an already traveled route of a vehicle and/or a plurality of vehicles.

24. A control unit configured to align digital maps by a control unit, the method comprising the following steps:
receiving data of a first map present in a first coordinate system and data of a second map present in a second coordinate system;
ascertaining, based on the received data, at least one trajectory within the first map and at least one trajectory within the second map; and
aligning the data of the first map in the first coordinate system and the data of the second map in the second coordinate system with one another based on the ascertained at least one trajectory within the first map and the ascertained at least one trajectory within the second map.

25. A non-transitory machine-readable memory medium on which is stored a computer program for aligning digital maps by a control unit, the computer program, when executed by a computer or control unit, causing the computer or control unit to perform the following steps:
receiving data of a first map present in a first coordinate system and data of a second map present in a second coordinate system;
ascertaining, based on the received data, at least one trajectory within the first map and at least one trajectory within the second map; and
aligning the data of the first map in the first coordinate system and the data of the second map in the second coordinate system with one another based on the ascertained at least one trajectory within the first map and the ascertained at least one trajectory within the second map.
